(19) United States
(12) Patent Application Publication
(10) Pub. No.: US 2026/0029740 A1
(43) Pub. Date: Jan. 29, 2026

(54) IMAGE FORMING SYSTEM, NON-TRANSITORY COMPUTER READABLE MEDIUM, AND METHOD

(71) Applicant: FUJIFILM BUSINESS INNOVATION CORP., Tokyo (JP)

(72) Inventor: Tomokazu KURITA, Kanagawa (JP)

(73) Assignee: FUJIFILM BUSINESS INNOVATION CORP., Tokyo (JP)

(21) Appl. No.: 19/032,644

(22) Filed: Jan. 21, 2025

(30) Foreign Application Priority Data
Jul. 26, 2024 (JP) 2024-120709

(51) Int. Cl. G03G 15/00; G03G 15/16; G03G 15/20

(52) U.S. Cl. CPC G03G 15/5029; G03G 15/1605; G03G 15/1675; G03G 15/2039; G03G 15/2064; G03G 15/6585; G03G 2215/00919

(57) ABSTRACT

An image forming system includes a processor configured to obtain a type of printed material to be generated from a medium and control, in accordance with the obtained type of printed material, performance for applying pressure-scaling toner, which demonstrates an adhesion function when deformed by pressure, to the medium.

### CROSS-REFERENCE TO RELATED APPLICATIONS

This application is based on and claims priority under 35 USC 119 from Japanese Patent Application No. 2024-120709 filed Jul. 26, 2024.

### BACKGROUND

### (i) Technical Field

The present disclosure relates to an image forming system, a non-transitory computer readable medium, and a method.

### (ii) Related Art

Pressure-sealed postcards, each of which is obtained by performing printing on a sheet of paper, folding the sheet in two or more, and sealing the folded sheet, are generally known. Pressure-sealed postcards are often used as direct mails (DMs) for sales promotion or other purposes. This is because the pressure-sealed postcards, which are folded sheets of paper, can increase the amount of information that can be included without increasing postage. In addition, since the inside of the pressure-sealed postcards can be seen only after unsealing, confidentiality can be assured. The pressure-sealed postcards, therefore, are suitable for, for example, notifying of personal information.

Pressure-sealing toners that demonstrate an adhesion function are available these years. When high pressure and heat are applied to pressure-sealing toner, pressure-responsive resin contained in the pressure-sealing toner reacts and functions like adhesive to adhere sheets of paper to each other. When pressure-sealing toner is used, a gluing step of applying an adhesive material to an inside surface to be adhered can be omitted.

### SUMMARY

It is convenient to be able to adjust adhesion for adhering a folded printed material in accordance with a type of printed material when the printed material is adhered using pressure-sealing toner.

Aspects of non-limiting embodiments of the present disclosure relate to adjustment of adhesion for a printed material using pressure-sealing toner according to a type of printed material.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a processor configured to obtain a type of printed material to be generated from a medium and control, in accordance with the obtained type of printed material, performance for applying pressure-sealing toner, which demonstrates an adhesion function when deformed by pressure, to the medium.

### BRIEF DESCRIPTION OF THE DRAWINGS

An exemplary embodiment of the present disclosure will be described in detail based on the following figures, wherein:

FIG. 1 is a diagram illustrating an example of a block configuration of an image forming apparatus in an exemplary embodiment;

FIG. 2A is a diagram schematically illustrating a second transfer unit in the exemplary embodiment and illustrating a state before pressure-sealing toner is transferred from an intermediate transfer belt onto a sheet of paper;

FIG. 2B is a diagram illustrating a state after the pressure-sealing toner is transferred from the intermediate transfer belt onto the sheet of paper in a case where a user has selected a confidential type in the exemplary embodiment;

FIG. 2C is a diagram illustrating a state after the pressure-sealing toner is transferred from the intermediate transfer belt onto the sheet of paper in a case where the user has selected a non-confidential type in the exemplary embodiment; and

FIG. 3 is a diagram schematically illustrating a part of a fixing unit in the exemplary embodiment and illustrating a state where the pressure-sealing toner transferred onto the sheet of paper is fixed.

### DETAILED DESCRIPTION

An exemplary embodiment of the present disclosure will be described hereinafter on the basis of the drawings.

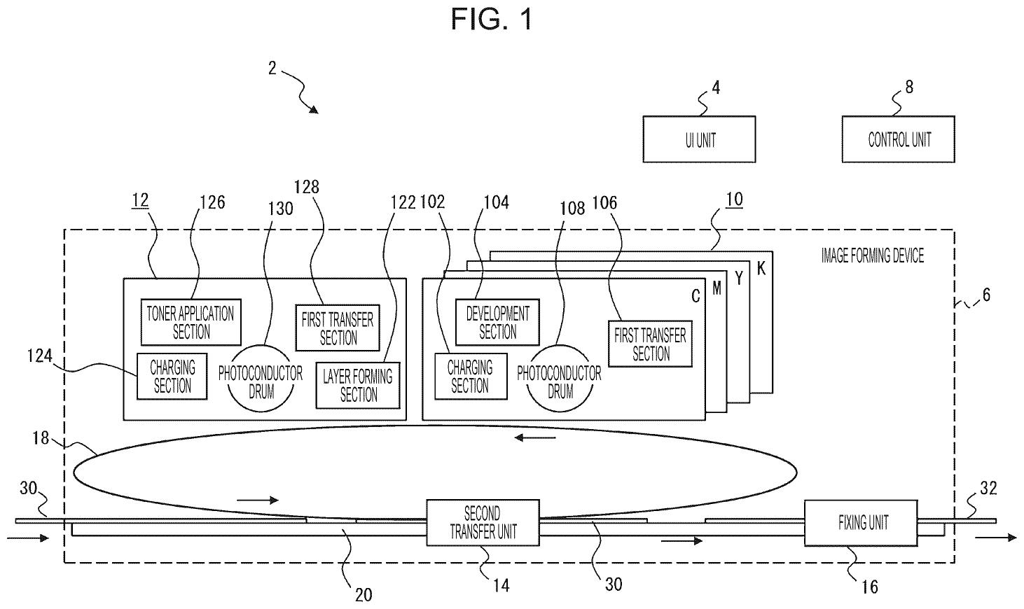

FIG. 1 is a diagram illustrating an example of a block configuration of an image forming apparatus 2 according to the present exemplary embodiment. The image forming apparatus 2 according to the present exemplary embodiment is an image forming system according to an exemplary embodiment of the present disclosure, and generates printed materials by forming images on a medium. A printed material processing system that processes a printed material into a pressure-sealed postcard, a pressure-sealed envelope, or another letter through cutting, folding, pressure sealing, and other steps is generally installed at a stage subsequent to the image forming apparatus 2.

The image forming apparatus 2 is a production color printer having a printing function and an apparatus with a built-in computer. The image forming apparatus 2, therefore, includes a central processing unit (CPU), a read-only memory (ROM), a random-access memory (RAM), a hard disk drive (HDD) as storage means, a network interface as communication means, and an operation panel as a user interface. Components other than those related to pressure-sealing toner, which will be described later, may be configured as before.

As illustrated in FIG. 1, the image forming apparatus 2 includes a user interface (UI) unit 4, an image forming device 6, and a control unit 8. Components that are not used for description of the present exemplary embodiment, including network means, for example, are omitted. A paper transport path, a paper tray, and the like related to printing are also omitted from the drawing.

The UI unit 4, which is achieved by an operation panel, receives instructions from a user and displays information. The image forming device 6 achieves the printing function of the image forming apparatus 2 and creates a printed material 32 by forming an image on a sheet of paper 30, which is a printing medium. The control unit 8 controls operation of each component included in the image forming apparatus 2. The control unit 8 may control operation of each component in accordance with an instruction from a server that is not illustrated.

The image forming device 6 includes image forming units 10, a pressure-scaling toner application unit 12, a second transfer unit 14, a fixing unit 16, an intermediate transfer belt 18, and a transport path 20, and forms an image on the sheet of paper 30 through a predetermined image forming process. The predetermined image forming process generally includes steps of exposure, development, transfer, fixing, cleaning, and elimination of static charge. In the present exemplary embodiment, too, an image is formed on the sheet of paper 30 through a basically similar process. FIG. 1 illustrates blocks corresponding to the charging step, the development step, the transfer step, and the fixing step of the image forming process, that is, charging sections 102, development sections 104, transfer units and a transfer section (first transfer sections 106 and the second transfer unit 14), and the fixing unit 16.

The image forming device 6 includes the image forming units 10 (i.e., image forming engines) corresponding to different colors. The colors are cyan (C), magenta (M), yellow (Y), and black (K). Toner cartridges corresponding to these colors are mounted on the image forming apparatus 2. The image forming units 10 each include a charging section 102, a development section 104, a first transfer section 106, and a photoconductor drum 108.

In the charging step, charging devices including charging rollers (corresponding to the charging sections 102) execute a charging function to charge the photoconductor drums 108. In the exposure step, exposure devices including lasers execute an exposure function to reduce potentials of parts of surfaces of the charged photoconductor drums 108 with which printing in the corresponding colors is performed on the sheet of paper 30. In the development step, development devices including magnetic rolls (corresponding to the development sections 104) execute a development function to apply toners of the corresponding colors to the parts of the surfaces of the photoconductor drums 108 where the potentials have been reduced. The transfer step includes first transfer performed by the first transfer sections 106 and second transfer performed by the second transfer unit 14. In the first transfer, transfer devices including transfer rolls (corresponding to the first transfer sections 106) execute a transfer function to transfer the toners of the corresponding colors applied to the photoconductor drums 108 onto the intermediate transfer belt 18. In the second transfer, a transfer device including a second transfer roll (corresponding to the second transfer unit 14) executes a transfer function to transfer the toners applied to the intermediate transfer belt 18 onto the sheet of paper 30 transported along the transport path 20. In the fixing step, the toners transferred onto the sheet of paper 30 are fixed when the sheet of paper 30 is transported to a nip between a heating roll and a pressure roll along the transport path 20.

The image forming units 10 sequentially transfer the toners of C, M, Y, and K onto the intermediate transfer belt 18 by performing the image forming process. As a result, the toners of the four colors overlap one another to form CMYK layers.

The image forming apparatus 2 in the present exemplary embodiment includes the pressure-scaling toner application unit 12 as a more special image forming engine separately from the general CMYK image forming engines. “Pressure-sealing toner” refers to special toner that achieves a sealing function when deformed by pressure. More specifically, the pressure-sealing toner is a colorless transparent toner in which pressure-responsive resin is finely dispersed, and only when high pressure is applied, the resin softens and achieves a function of adhering sheets of paper to each other. The four toner cartridges (not illustrated) filled with the C, M, Y, and K color toners (hereinafter collectively referred to as “color toners”) are mounted on the image forming apparatus 2, and the same applies to the pressure-sealing toner.

The pressure-sealing toner application unit 12 includes a layer forming section 122, a charging section 124, a toner application section 126, a first transfer section 128, and a photoconductor drum 130. The layer forming section 122 applies a pressure-scaling toner layer to the intermediate transfer belt 18 (i.e., the CMYK layers), onto which the color toners have been transferred, as a base layer for applying the pressure-sealing toner to the CMYK layers. The pressure-scaling toner layer is basically a colorless transparent special toner layer formed in accordance with size of the sheet of paper 30. The charging section 124 charges the photoconductor drum 130. The toner application section 126 applies the pressure-scaling toner to parts of the photoconductor drum 130 where potentials have been reduced. The first transfer section 128 transfers the pressure-sealing toner applied to the photoconductor drum 130 onto the intermediate transfer belt 18. Strictly speaking, since the pressure-sealing toner layer has been formed on the intermediate transfer belt 18 at a position at which the toners are transferred, the pressure-sealing toner is transferred onto the pressure-sealing toner layer.

The second transfer unit 14 then functions as a transfer device that collectively transfers the toners (including the pressure-scaling toner layer) transferred onto the intermediate transfer belt 18 onto the sheet of paper 30 with electric force. The fixing unit 16 functions as a fixing device that heats and pressurizes the toners transferred onto the sheet of paper 30 to fix the toners. The CMYK layers and the pressure-sealing toner layers are formed on the intermediate transfer belt 18, and the pressure-sealing toner is also applied. The transport path 20 is a path used until the sheet of paper 30 fed from a paper feed tray is discharged from the printed material processing system at the subsequent stage.

The image forming apparatus 2 generates a full-color printed material 32 by performing the image forming process with the above configuration. The pressure-scaling toner has been applied to the generated printed material 32 in addition to the color toners.

The components 4 to 8 of the image forming apparatus 2 are achieved as a result of coordinated action of a computer mounted on the image forming apparatus 2 and a program executable by a CPU mounted on the computer. The program used in the present exemplary embodiment can of course be provided using the communication means, but can also be stored in a computer readable storage medium such as a universal serial bus (USB) memory and provided. The program provided from the communication means or the storage medium is installed on the computer, and the CPU sequentially executes the program to achieve various types of processing. The present disclosure can be applied to a program and a program product.

As an example, the image forming system according to the present exemplary embodiment is achieved by a single image forming apparatus 2 in the above description, the image forming system may be achieved by a plurality of apparatuses, instead.

Next, operations in the present exemplary embodiment will be described.

The image forming apparatus 2 may be the same as a general production color printer in terms of an image forming process in which color toners are used, except for the application of the pressure-scaling toner to the sheet of paper 30. That is, the control unit 8 receives an instruction from the server that is not illustrated, and forms the CMYK layers by controlling operation of the image forming units 10 in accordance with the instruction. The control unit 8 in the present exemplary embodiment also controls operation of the pressure-scaling toner application unit 12 in accordance with an instruction from the server. In particular, in the present exemplary embodiment, the control unit 8 obtains, with respect to the application of the pressure-scaling toner to the printed material 32, a type of printed material 32 to be generated from the sheet of paper 30, and controls, in accordance with the obtained type of printed material 32, a mode of the pressure-sealing toner applied to the printed material 32. The control unit 8 may be separately provided for the color toners and the pressure-scaling toner.

In the present exemplary embodiment, a case will be described where two types of generated printed material 32, namely a confidential type, which is a first type of printed material 32, and a non-confidential type, which is a second type of printed material 32, are generated.

“Confidential” means a desire that a sealed letter be unsealed and read by a person to whom the letter is addressed, or treatment of the letter as such. The “confidential type” in the present exemplary embodiment is printed materials 32 to be treated confidentially, and refers to printed materials in general whose content should not be exposed to a third party for confidentiality purposes. When the confidential type is a DM, for example, accidental unsealing during delivery needs to be avoided. A “non-confidential type” in the present exemplary embodiment, on the other hand, is printed materials 32 other than the confidential type. The non-confidential type refers to printed materials in general that require less confidentiality than the confidential type. It is needless to say that even the non-confidential type should prevent an adhesive surface from peeling off, but a requirement level thereof need not be as high as that of the confidential type.

For this reason, the confidential type requires stronger adhesion than the non-confidential type in order to make an adhesive surface hard to peel off. As described later, the user specifies whether a printed material 32 is of the confidential type or the non-confidential type. The adhesive surface refers to a surface of a printed material 32 to which the pressure-scaling toner is applied.

In order to make an adhesive surface hard to peel off, the mode of the pressure-scaling toner applied to the printed material 32 is controlled in the present exemplary embodiment. The term “mode” usually refers to an appearance, a structure, or a state of an object, but in the present exemplary embodiment, the amount of pressure-sealing toner applied to the printed material 32 or positions of the pressure-sealing toner applied to the printed material 32 are controlled as the mode of the pressure-sealing toner. Adhesion of the adhesive surface can thus be adjusted.

As described above, the image forming apparatus 2 in the present exemplary embodiment applies the pressure-sealing toner to the pressure-sealing toner layer formed on the CMYK layers after forming the CMYK layers on the intermediate transfer belt 18 using the color toners. The control unit 8 controls, in accordance with the type of printed material 32, the amount of pressure-scaling toner applied by the pressure-sealing toner application unit 12 and the positions of the pressure-sealing toner.

For example, the control unit 8 displays information on the UI unit 4, that is, the operation panel, such that the user can select whether the type of printed material 32 is the confidential type or the non-confidential type. The user selects the confidential type or the non-confidential type on the operation panel as the type of printed material 32. After the user selects the type of printed material 32, the control unit 8 forms the CMYK layers on the intermediate transfer belt 18 regardless of the selected type of printed material 32 by controlling the image forming units 10 in accordance with an instruction from the server as described above. The control unit 8 forms the pressure-scaling toner layer on the intermediate transfer belt 18 by controlling the pressure-scaling toner application unit 12, and applies the pressure-sealing toner to the pressure-sealing toner layer in a predetermined pattern. In the present exemplary embodiment, the pressure-sealing toner is equally applied to the intermediate transfer belt 18 without distinguishing the confidential type and the non-confidential type. The amount of pressure-scaling toner applied for the confidential type may of course be larger than for the non-confidential type in order to achieve stronger adhesion for the confidential type.

What is different between the confidential type and the non-confidential type in the present exemplary embodiment in terms of processing is operation of the second transfer unit 14 or the fixing unit 16.

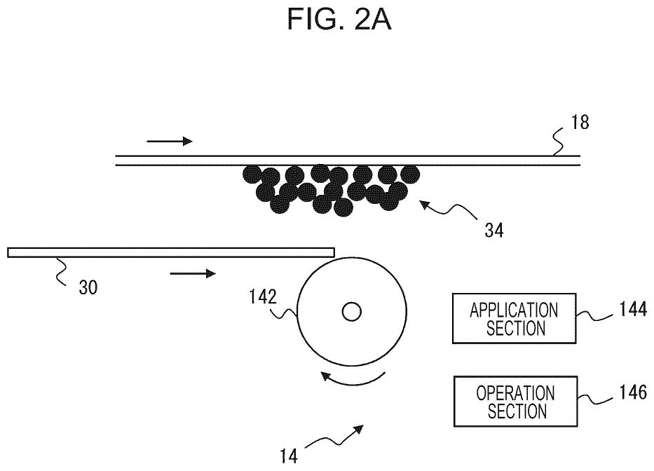

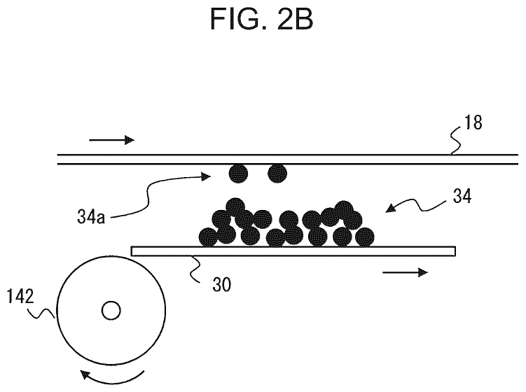

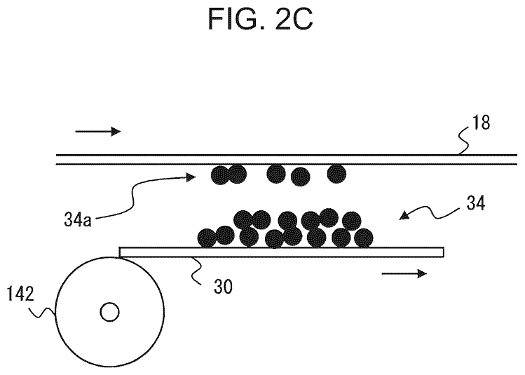

FIG. 2A is a diagram schematically illustrating the second transfer unit 14 in the present exemplary embodiment, and illustrates a state before the pressure-sealing toner 34 is transferred from the intermediate transfer belt 18 onto the sheet of paper 30. The second transfer unit 14 includes a second transfer roll 142, an application section 144 that applies a voltage to the second transfer roll 142, and an operation section 146 that drives the second transfer roll 142 or adjusts nip pressure. In the present exemplary embodiment, except that control performed on the components 142 to 146 included in the second transfer unit 14 is different, a general device configuration may be employed as hardware configuration.

The pressure-scaling toner application unit 12 has applied the pressure-scaling toner 34 to the intermediate transfer belt 18. The intermediate transfer belt 18 is rotated by a drive roll (not illustrated), and a position at which the pressure-scaling toner 34 has been applied moves from the pressure-sealing toner application unit 12 to the second transfer unit 14. The color toners and the pressure-sealing toner layer on the intermediate transfer belt 18 that are not used for the description of the present exemplary embodiment are omitted from the drawing. The sheet of paper 30 is transported to the second transfer unit 14 along the transport path 20. If the pressure-scaling toner 34 applied to the intermediate transfer belt 18 is negatively charged, the second transfer roll 142 applies positive static electricity opposite the pressure-scaling toner 34 to the sheet of paper 30. As a result, the pressure-scaling toner 34 is attracted toward the sheet of paper 30 at a position of the second transfer roll 142 and moves. The second transfer unit 14 thus transfers the pressure-scaling toner to the sheet of paper 30.

FIGS. 2B and 2C are, as with FIG. 2A, diagrams schematically illustrating the second transfer roll 142, and illustrate a state after the pressure-sealing toner 34 is transferred from the intermediate transfer belt 18 onto the sheet of paper 30. FIG. 2B illustrates a state after the transfer in a case where the user has selected the confidential type, and FIG. 2C illustrates a state after the transfer in a case where the user has selected the non-confidential type.

The control unit 8 in the present exemplary embodiment controls transfer performance of the second transfer unit 14 in accordance with a type of printed material, that is, whether the printed material is of the confidential type or the non-confidential type. The control unit 8, therefore, controls transport speed of the intermediate transfer belt 18.

As described above, a printed material 32 of the confidential type requires stronger adhesion than a printed material 32 of the non-confidential type in order to make an adhesion surface hard to peel off. When the user has selected the confidential type, therefore, the control unit 8 performs control such that the transport speed of the intermediate transfer belt 18 for the confidential type becomes lower than that for the non-confidential type. The control unit 8 also performs control such that rotation speed of the second transfer roll 142 becomes accordingly lower. When the transport speed for the non-confidential type is 355 mm/s, for example, a lower transport speed, namely 177 mm/s, for example, is set for the confidential type. By reducing the transport speed, it is possible to increase time taken for the pressure-scaling toner 34 to move from the intermediate transfer belt 18 to the sheet of paper 30, and a larger amount of pressure-sealing toner 34 can be moved for the confidential type than for the non-confidential type.

FIGS. 2B and 2C assume such situations. As can be seen by comparing FIG. 2B, which illustrates the confidential type, and FIG. 2C, which illustrates the non-confidential type, a larger amount of pressure-sealing toner 34a remains on the intermediate transfer belt 18 after the transfer for the non-confidential type, where the transport speed is higher. That is, in the case of the confidential type, a larger amount of pressure-sealing toner 34 can be reliably transferred than in the case of the non-confidential type. When a larger amount of pressure-sealing toner 34 is transferred to the sheet of paper 30, stronger adhesion can be achieved.

As another method for controlling the transfer performance of the second transfer unit 14 in accordance with the type of printed material, the control unit 8 may control a second transfer voltage (also called a “second transfer bias”) applied to the second transfer roll 142. That is, the positive static electricity applied to the sheet of paper 30 is controlled. When the voltage for the non-confidential type is 5 to 8 kv, for example, a higher voltage, namely 8 to 12 kv, is set for the confidential type. By performing control such that the voltage applied to the second transfer roll 142 for the confidential type becomes higher than for the non-confidential type, a larger amount of pressure-sealing toner 34 is thus applied to the sheet of paper 30 of the confidential type than the sheet of paper 30 of the non-confidential type as illustrated in FIGS. 2B and 2C.

As another method for controlling transfer performance of the second transfer unit 14 in accordance with the type of printed material, the control unit 8 may control nip pressure with which the second transfer roll 142 as a nip roll nips the intermediate transfer belt 18 and the sheet of paper 30 together with a roll that is not illustrated. The nip pressure is pressure with which the sheet of paper 30 is pressed against the pressure-scaling toner 34 transferred onto the intermediate transfer belt 18 as a result of the first transfer. When the nip pressure for the non-confidential type is 50 to 100 gf/cm, for example, a higher pressure, namely 100 to 200 gf/cm, is set for the confidential type. By performing control such that the nip pressure for the confidential type becomes higher than for the non-confidential type, a larger amount of pressure-sealing toner 34 is thus transferred onto the sheet of paper 30 of the confidential type than the sheet of paper 30 of the non-confidential type as illustrated in FIGS. 2B and 2C.

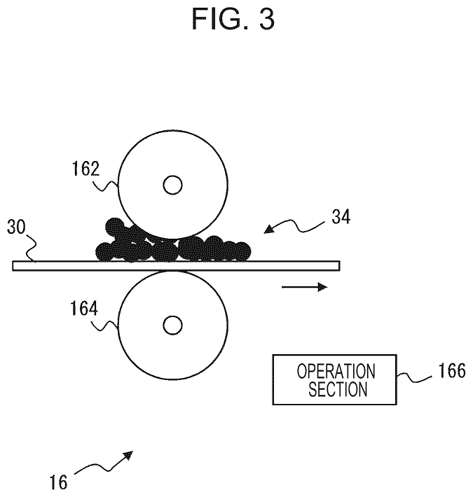

FIG. 3 is a diagram schematically illustrating a part of the fixing unit 16 in the present exemplary embodiment, and illustrates a state where the pressure-sealing toner 34 transferred onto the sheet of paper 30 is fixed. The fixing unit 16 includes a heat roll 162, which is generally called a fixing roll, a pressure roll 164, and an operation section 166 that drives the rolls 162 and 164 and that also adjusts temperature and pressure. In the present exemplary embodiment, except that control performed on the components 162 to 166 included in the fixing unit 16 is different, a general device configuration may be employed as hardware configuration.

The sheet of paper 30 onto which the second transfer unit 14 has transferred the pressure-scaling toner 34 is transported to a nip between the heat roll 162 and the pressure roll 164. The pressure-sealing toner 34 is fixed on the sheet of paper 30 by a temperature applied by the heat roll 162 and a pressure applied by the pressure roll 164 when the pressure-sealing toner 34 moves to the nip between the rolls 162 and 164.

The control unit 8 in the present exemplary embodiment controls fixing performance of the fixing unit 16 in accordance with the type of printed material, that is, whether the printed material is of the confidential type or the non-confidential type. As a method for achieving this, the control unit 8 controls temperature of the heat roll 162.

As described above, a printed material 32 of the confidential type requires stronger adhesion than a printed material 32 of the non-confidential type in order to make an adhesion surface hard to peel off. When the user has selected the confidential type, therefore, the control unit 8 performs control for the confidential type such that the temperature applied by the heat roll 162 to the pressure-sealing toner 34 becomes higher than for the non-confidential type. When the temperature for the non-confidential type is 180° C., for example, a higher temperature, namely 210° C., for example, is set for the confidential type. It is needless to say that the temperature to be set needs to be low enough for the pressure-scaling toner 34 not to soften and become unable to demonstrate the adhesion function. When the temperature of the heat roll 162 is high, a high temperature is applied to the pressure-sealing toner 34, and firmer fixing can be performed for the confidential type than for the non-confidential type.

As another method for controlling the fixing performance of the fixing unit 16 in accordance with the type of printed material, the control unit 8 may control the pressure applied by the pressure roll 164 to the sheet of paper 30 and the pressure-scaling toner 34. That is, the pressure applied to the sheet of paper 30 can be increased by moving the pressure roll 164 toward the heat roll 162, and the control unit 8 performs control such that the pressure applied by the pressure roll 164 to the sheet of paper 30 and the pressure-scaling toner 34 for the confidential type becomes higher than for the non-confidential type. When the pressure applied to the sheet of paper 30 and the pressure-sealing toner 34 is increased, the pressure-sealing toner 34 can be fixed to the sheet of paper 30 more firmly, and firmer fixing can be performed for the confidential type than for the non-confidential type.

As described above, performance for applying a pressure-sealing toner to a sheet of paper can be mechanically or electrically controlled in accordance with a type of printed material in the present exemplary embodiment. As a result, stronger adhesion than for the non-confidential type required by the confidential type can be achieved.

Although the user specifies whether the type of printed material is the confidential type or the non-confidential type in the present exemplary embodiment, the user need not necessarily specify the type of printed material. For example, whether the type of printed material is the confidential type may be automatically determined and obtained by analyzing information to be printed on a sheet of paper, that is, for example, presence or absence of a name or an address of a person, presence or absence of words or phrases that can evoke a sense of confidentiality, or the like, instead.

Although there are two types of printed material, namely the confidential type and the non-confidential type, depending on information to be printed in the above example, three or more types of printed material may be provided on the basis of another index, instead, and pressure-sealing toner may be applied in modes according to the different types, instead.

The type of printed material is not limited to information to be included in a printed material and the like, and two or more types may be provided in accordance with a type of paper, that is, for example, characteristics of the printing medium including thickness and material.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system including
a processor configured to:
   obtain a type of printed material to be generated from a medium; and
   control, in accordance with the obtained type of printed material, performance for applying pressure-sealing toner, which demonstrates an adhesion function when deformed by pressure, to the medium.
      (((2)))

The image forming system according to (((1))), further including:
a transfer device that transfers the pressure-sealing toner onto the medium,
in which the processor is configured to control transfer performance of the transfer device in accordance with the type of printed material when transferring the pressure-sealing toner applied to a transfer belt included in the transfer device onto the medium.
   (((3)))

The image forming system according to (((2))),
in which the processor is configured to perform control such that transport speed of the transfer belt becomes lower for a printed material of a first type than for a printed material of a second type, which does not require adhesion as strong as the printed material of the first type.
   (((4)))

The image forming system according to (((2))),
in which the processor is configured to perform control such that a voltage applied to a second transfer roll included in the transfer device becomes higher for a printed material of a first type than for a printed material of a second type, which does not require adhesion as strong as the printed material of the first type.
   (((5)))

The image forming system according to (((2))),
in which the processor is configured to perform control such that nip pressure of a nip roll included in the transfer device becomes higher for a printed material of a first type than for a printed material of a second type, which does not require adhesion as strong as the printed material of the first type.
   (((6)))

The image forming system according to any one of (((1))) to (((5))), further including:
a fixing device that fixes the pressure-sealing toner transferred onto the medium,
in which the processor is configured to control fixing performance of the fixing device in accordance with the type of printed material when fixing the pressure-sealing toner on the medium by transporting the medium to a nip between a heat roll and a pressure roll included in the fixing device.
   (((7)))

The image forming system according to (((6))),
in which the processor is configured to perform control such that a temperature applied by the heat roll to the pressure-sealing toner becomes higher for a printed material of a first type than for a printed material of a second type, which does not require adhesion as strong as the printed material of the first type.
   (((8)))

The image forming system according to (((6))),
in which the processor is configured to perform control such that a pressure applied by the pressure roll to the medium becomes higher for a printed material of a first type than for a printed material of a second type, which does not require adhesion as strong as the printed material of the first type.
   (((9)))

The image forming system according to any one of (((3))), (((4))), (((5))), (((7))), and (((8))),
in which the printed material of the first type is a printed material of a confidential type, and
in which the printed material of the second type is a printed material of a type other than the confidential type.
   (((10)))

A program causing a computer to execute a process including:
obtaining a type of printed material to be generated from a medium; and
controlling, in accordance with the obtained type of printed material, performance for applying pressure-scaling toner, which demonstrates an adhesion function when deformed by pressure, to the medium.

What is claimed is:

1. An image forming system comprising:
a processor configured to:
obtain a type of printed material to be generated from a medium; and
control, in accordance with the obtained type of printed material, performance for applying pressure-sealing toner, which demonstrates an adhesion function when deformed by pressure, to the medium.

2. The image forming system according to claim 1, further comprising:
a transfer device that transfers the pressure-sealing toner onto the medium,
wherein the processor is configured to control transfer performance of the transfer device in accordance with the type of printed material when transferring the pressure-sealing toner applied to a transfer belt included in the transfer device onto the medium.

3. The image forming system according to claim 2,
wherein the processor is configured to perform control such that transport speed of the transfer belt becomes lower for a printed material of a first type than for a printed material of a second type, which does not require adhesion as strong as the printed material of the first type.

4. The image forming system according to claim 2,
wherein the processor is configured to perform control such that a voltage applied to a second transfer roll included in the transfer device becomes higher for a printed material of a first type than for a printed material of a second type, which does not require adhesion as strong as the printed material of the first type.

5. The image forming system according to claim 2,
wherein the processor is configured to perform control such that nip pressure of a nip roll included in the transfer device becomes higher for a printed material of a first type than for a printed material of a second type, which does not require adhesion as strong as the printed material of the first type.

6. The image forming system according to claim 1, further comprising:
a fixing device that fixes the pressure-sealing toner transferred onto the medium,
wherein the processor is configured to control fixing performance of the fixing device in accordance with the type of printed material when fixing the pressure-sealing toner on the medium by transporting the medium to a nip between a heat roll and a pressure roll included in the fixing device.

7. The image forming system according to claim 6,
wherein the processor is configured to perform control such that a temperature applied by the heat roll to the pressure-sealing toner becomes higher for a printed material of a first type than for a printed material of a second type, which does not require adhesion as strong as the printed material of the first type.

8. The image forming system according to claim 6,
wherein the processor is configured to perform control such that a pressure applied by the pressure roll to the medium becomes higher for a printed material of a first type than for a printed material of a second type, which does not require adhesion as strong as the printed material of the first type.

9. The image forming system according to claim 3,
wherein the printed material of the first type is a printed material of a confidential type, and
wherein the printed material of the second type is a printed material of a type other than the confidential type.

10. The image forming system according to claim 4,
wherein the printed material of the first type is a printed material of a confidential type, and
wherein the printed material of the second type is a printed material of a type other than the confidential type.

11. The image forming system according to claim 5,
wherein the printed material of the first type is a printed material of a confidential type, and
wherein the printed material of the second type is a printed material of a type other than the confidential type.

12. The image forming system according to claim 7,
wherein the printed material of the first type is a printed material of a confidential type, and
wherein the printed material of the second type is a printed material of a type other than the confidential type.

13. The image forming system according to claim 8,
wherein the printed material of the first type is a printed material of a confidential type, and
wherein the printed material of the second type is a printed material of a type other than the confidential type.

14. A non-transitory computer readable medium storing a program causing a computer to execute a process comprising:
obtaining a type of printed material to be generated from a medium; and
controlling, in accordance with the obtained type of printed material, performance for applying pressure-sealing toner, which demonstrates an adhesion function when deformed by pressure, to the medium.

15. A method comprising:
obtaining a type of printed material to be generated from a medium; and
controlling, in accordance with the obtained type of printed material, performance for applying pressure-sealing toner, which demonstrates an adhesion function when deformed by pressure, to the medium.
